(19) United States
(12) Patent Application Publication
(10) Pub. No.: US 2002/0073257 A1
(43) Pub. Date: Jun. 13, 2002

(54) Transferring foreign protocols across a system area network

(75) Inventors: Bruce Leroy Beukema, Hayfield, MN (US); Ronald Edward Fuhs, Rochester, MN (US); Danny Marvin Neal, Round Rock, TX (US); Renato John Recio, Austin, TX (US); Steven L. Rogers, Rochester, MN (US); Steven Mark Thurber, Austin, TX (US); Bruce Marshall Walk, Rochester, MN (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 09/731,998

(22) Filed: Dec. 7, 2000

(51) Int. Cl. G06F 13/42

(52) U.S. Cl. 710/105

(57) ABSTRACT

A method, system, and apparatus for processing foreign protocol requests, such as PCI transactions, across a system area network (SAN) utilizing a data packet protocol is provided while maintaining the other SAN traffic. In one embodiment, a HCA receives a request for a load or store operation from a processor to an I/O adapter using a protocol which is foreign to the system area network, such as a PCI bus protocol. The HCA encapsulates the request into a data packet and places appropriate headers and trailers in the data packet to ensure that the data packet is delivered across the SAN fabric to an appropriate TCA to which the requested I/O adapter is connected. The TCA receives the data packet, determines that it contains a foreign protocol request, and decodes the data packet to obtain the foreign protocol request. The foreign protocol request is then transmitted to the appropriate I/O adapter.

### Cross References to Related Applications and Patents

The present invention is related to applications entitled A System Area Network of End-to-End Context via Reliable Datagram Domains, serial no. ______, attorney docket no. AUS9-2000-0625-US1, filed ______; Method and Apparatus for Pausing a Send Queue without Causing Sympathy Errors, serial no. ______, attorney docket no. AUS9-2000-0626-US1, filed ______; Method and Apparatus to Perform Fabric Management, serial no. ______, attorney docket no. AUS9-2000-0627-US1, filed ______; End Node Partitioning using LMC for a System Area Network, serial no. ______, attorney docket no. AUS9-2000-0628-US1, filed ______; Method and Apparatus for Dynamic Retention of System Area Network Management Information in Non-Volatile Store, serial no. ______, attorney docket no. AUS9-2000-0629-US1, filed ______; Method and Apparatus for Retaining Network Security Settings Across Power Cycles, serial no. ______, attorney docket no. AUS9-2000-0630-US1, filed ______; serial no. ______, attorney docket no. AUS9-2000-0631-US1, filed ______; Method and Apparatus for Reliably Choosing a Master Network Manager During Initialization of a Network Computing System, serial no. ______, attorney docket no. AUS9-2000-0632-US1, filed ______; Method and Apparatus for Ensuring Scalable Mastership During Initialization of a System Area Network, serial no. ______, attorney docket no. AUS9-2000-0633-US1 filed ______; and Method and Apparatus for Using a Service ID for the Equivalent of a Port ID in a Network Computing System, serial no. ______, attorney docket no. AUS9-2000-0634-US1 filed ______, all of which are assigned to the same assignee, and incorporated herein by reference.

### BACKGROUND OF THE INVENTION

1. Technical Field

The present invention relates generally to an improved data processing system, and in particular to a method and apparatus for handling PCI transactions over a network that implements the Infiniband architecture.

2. Description of Related Art

In a System Area Network (SAN), the hardware provides a message passing mechanism which can be used for Input/Output devices (I/O) and interprocess communications between general computing nodes (IPC). Consumers access SAN message passing hardware by posting send/receive messages to send/receive work queues on a SAN channel adapter (CA). The send/receive work queues (WQ) are assigned to a consumer as a queue pair (QP). The messages can be sent over five different defined transport types: Reliable Connected (RC), Reliable datagram (RD), Unreliable Connected (UC), Unreliable Datagram (UD), and Raw Datagram (RawD). In addition there is a set of manufacturer definable operation codes that allow for different companies to define custom packets that still have the same routing header layouts. Consumers retrieve the results of the defined messages from a completion queue (CQ) through SAN send and receive work completions (WC). The manufacturer definable operations are not defined as to whether or not they use the same queuing structure as the defined packet types. Regardless of the packet type, the source channel adapter takes care of segmenting outbound messages and sending them to the destination. The destination channel adapter takes care of reassembling inbound messages and placing them in the memory space designated by the destination's consumer. Two channel adapter types are present, a host channel adapter (HCA) and a target channel adapter (TCA). The host channel adapter is used by general purpose computing nodes to access the SAN fabric. Consumers use SAN verbs to access host channel adapter functions. The software that interprets verbs and directly accesses the channel adapter is known as the channel interface (CI).

One disadvantage to these SAN fabric networks is that the I/O adapters and devices connected to the network must utilize this data packet communication protocol. However, there are many devices, such as, PCI I/O adapters, that do not use this protocol for communications, but that would be desirable to include into a SAN network. Therefore, there is a need for a method, system, and apparatus for incorporating PCI and PCI-X Input/Output Adapters (IOA) for use with the SAN fabric.

### SUMMARY OF THE INVENTION

The present invention provides a method, system, and apparatus for processing foreign protocol requests, such as PCI transactions, across a system area network (SAN) utilizing a data packet protocol while maintaining the other SAN traffic. In one embodiment, a HCA receives a request for a load or store operation from a processor to an I/O adapter using a protocol which is foreign to the system area network, such as a PCI bus protocol. The HCA encapsulates the request into a data packet and places appropriate headers and trailers in the data packet to ensure that the data packet is delivered across the SAN fabric to an appropriate TCA to which the requested I/O adapter is connected. The TCA receives the data packet, determines that it contains a foreign protocol request, and decodes the data packet to obtain the foreign protocol request. The foreign protocol request is then transmitted to the appropriate I/O adapter. In the other direction, Direct Memory Access and interrupt traffic from the I/O adapter to the system is received by the TCA using a foreign protocol. The TCA encapsulates the request into a data packet and places appropriate headers and trailers in the data packet to ensure that the data packet is delivered across the SAN fabric to the appropriate HCA. The HCA receives the data packet, determines that it contains a foreign protocol request, and decodes the data packet to obtain the foreign protocol request, and converts the request to the appropriate host transaction.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram of a network computing system in accordance with a preferred embodiment of the present invention;

FIG. 2 depicts a functional block diagram of a host processor node in accordance with a preferred embodiment of the present invention;

FIG. 3 depicts a diagram of a host channel adapter in accordance with a preferred embodiment of the present invention;

FIG. 4 depicts a diagram illustrating processing of work requests in accordance with a preferred embodiment of the present invention;

FIG. 5 depicts an illustration of a data packet in accordance with a preferred embodiment of the present invention;

FIG. 6 is a diagram illustrating a portion of a network computing system in accordance with a preferred embodiment of the present invention;

FIG. 7 is a diagram illustrating messaging occurring during establishment of a connection in accordance with a preferred embodiment of the present invention;

FIG. 8 depicts a flowchart illustrating an exemplary method of performing a store operation issued by a processor to a PCI I/O adapter over InfiniBand architecture in accordance with a preferred embodiment of the present invention;

FIG. 9 depicts a flowchart illustrating an exemplary method of performing a load operation from a processor to a PCI IOA in accordance with the present invention;

FIG. 10 depicts a flowchart illustrating an exemplary method of performing a direct memory access write operation from a PCI I/O adapter to system memory across an Infiniband system in accordance with a preferred embodiment of the present invention; and

FIG. 11 depicts a flowchart illustrating a direct memory access read operation from a PCI I/O adapter to system memory across an InfiniBand connection in accordance with a preferred embodiment of the present invention.

### DETAILED DESCRIPTION OF THE PREFERRED EMBODIMENT

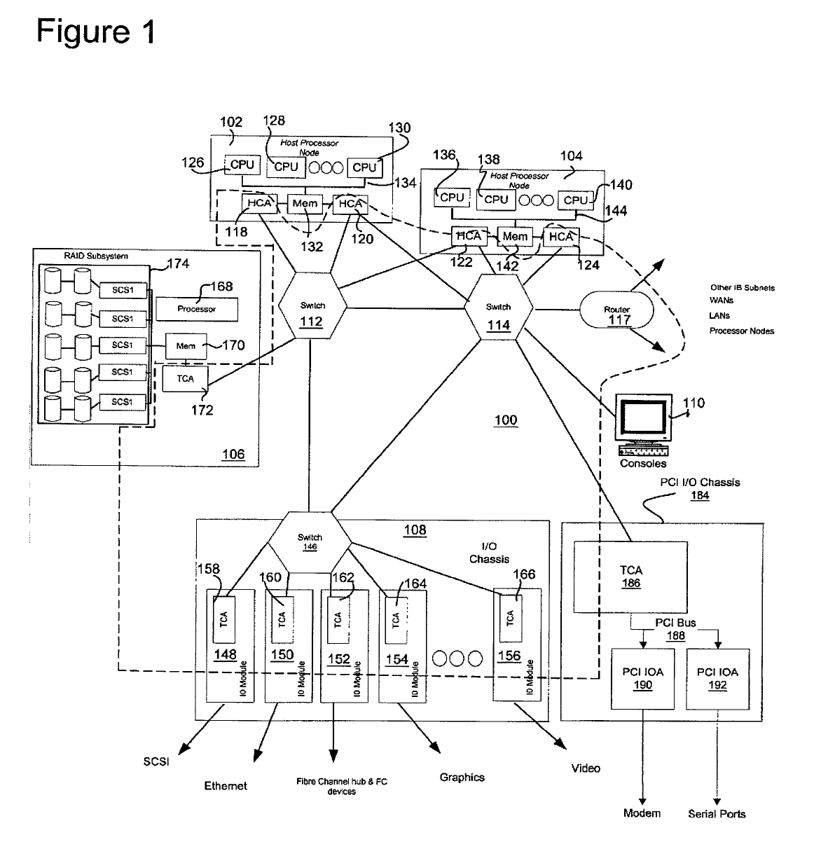

The present invention provides a network computing system having end nodes, switches, routers, and links interconnecting these components. The end nodes segment the message into packets and transmit the packets over the links. The switches and routers interconnects the end nodes and route the packets to the appropriate end node. The end nodes reassemble the packets into a message at the destination. With reference now to the figures and in particular with reference to FIG. 1, a diagram of a network computing system is illustrated in accordance with a preferred embodiment of the present invention. The network computing system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

SAN 100 is a high-bandwidth, low-latency network interconnecting nodes within the network computing system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, I/O chassis node 108, and PCI I/O Chassis node 184. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or frames in SAN 100.

In one embodiment of the present invention, an error handling mechanism in distributed computer systems is present in which the error handling mechanism allows for reliable connection or reliable datagram communication between end nodes in network computing system, such as SAN 100.

A message, as used herein, is an application-defined unit of data exchange, which is a primitive unit of communication between cooperating processes. A packet is one unit of data encapsulated by a networking protocol headers and/or trailer. The headers generally provide control and routing information for directing the frame through SAN. The trailer generally contains control and cyclic redundancy check (CRC) data for ensuring packets are not delivered with corrupted contents.

SAN 100 contains the communications and management infrastructure supporting both I/O and interprocessor communications (IPC) within a network computing system. The SAN 100 shown in FIG. 1 includes a switched communications fabric 100, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, RAID I/O subsystem 106, I/O chassis 108, and PCI I/O Chassis 184 include at least one channel adapter (CA) to interface to SAN 100. In one embodiment, each channel adapter is an endpoint that implements the channel adapter interface in sufficient detail to source or sink packets transmitted on SAN fabric 100. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapter 118 provides a connection to switch 112, host channel adapters 120 and 122 provide a connection to switches 112 and 114, and host channel adapter 124 provides a connection to switch 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the network computing system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

The I/O chassis 108 in FIG. 1 includes a switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop(FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

PCI I/O Chassis node 184 includes a TCA 186 and multiple PCI Input/Output Adapters (IOA) 190-192 connected to TCA 186 via PCI bus 188. In these examples, the IOAs take the form of adapter cards. Example adapter cards illustrated in FIG. 1 include a modem adapter card 190 and serial adapter card 192. TCA 186 encapsulates PCI transaction requests or responses received from PCI IOAs 190-192 into data packets for transmission across the SAN fabric 100 to an HCA, such as HCA 118. HCA 118 determines whether received data packets contain PCI transmissions and, if so, decodes the data packet to retrieve the encapsulated PCI transaction request or response, such as a DMA write or read operation. HCA 118 sends it to the appropriate unit, such as memory 132. If the PCI transaction was a DMA read request, the HCA then receives the response from the memory, such as memory 132, encapsulates the PCI response into a data packet, and sends the data packet back to the requesting TCA 186 across the SAN fabric 100. the TCA then decodes the PCI transaction from the data packet and sends the PCI transaction to PCI IOA 190 or 192 across PCI bus 188.

Similarly, store and load requests from a processor, such as, for example, CPU 126, to a PCI IOA, such as PCI IOA 190 or 192 are encapsulated into a data packet by the HCA 118 for transmission to the TCA 186 corresponding to the appropriate PCI IOA 190 or 192 across SAN fabric 100. The TCA 186 decodes the data packet to retrieve the PCI transmission and transmits the PCI store or load request and data to PCI IOA 190 or 192 via PCI bus 188. If the request is a load request, the TCA 186 then receives a response from the PCI IOA 190 or 192 which the TCA encapsulates into a data packet and transmits over the SAN fabric 100 to HCA 118 which decodes the data packet to retrieve the PCI data and commands and sends the PCI data and commands to the requesting CPU 126. Thus, PCI adapters may be connected to the SAN fabric 100 of the present invention.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernal process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in network computing system. With an I/O adapter attached to the SAN 100, the resulting I/O adapter node has substantially the same communication capability as any host processor node in SAN 100.

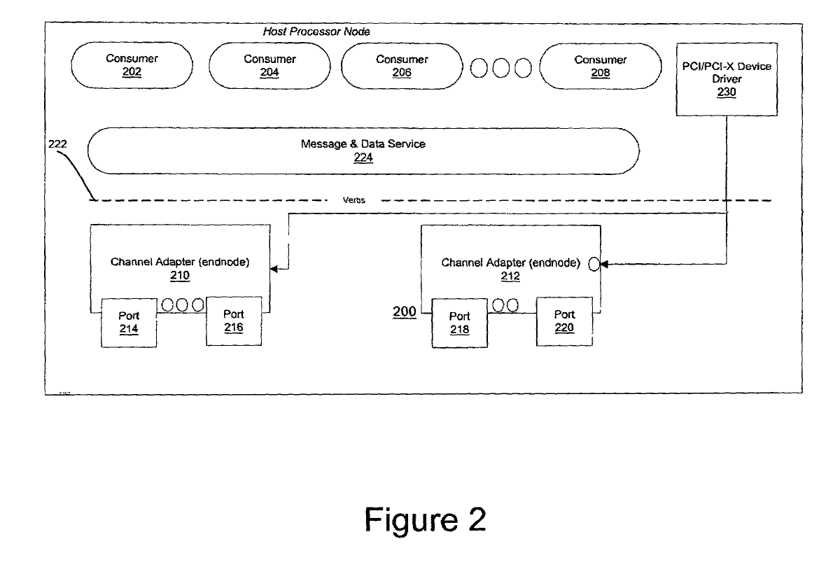

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208 and one or more PCI/PCI-X device drivers 230, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher level interface than the verb layer and is used to process messages and data received through channel adapter 210 and channel adapter 212. Message and data service 224 provides an interface to consumers 202-208 to process messages and other data. In addition, the channel adapter 210 and channel adapter 212 may receive load and store instructions from the processors which are targeted for PCI IOAs attached to the SAN. These bypass the verb layer, as shown in FIG. 2.

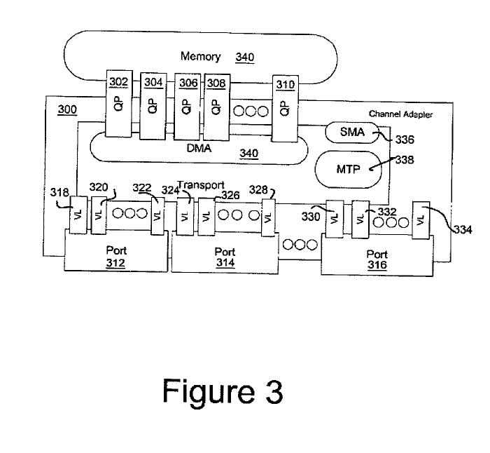

With reference now to FIG. 3, a diagram of a host channel adapter is depicted in accordance with a preferred embodiment of the present invention. Host channel adapter 300 shown in FIG. 3 includes a set of queue pairs (QPs) 302-310, which are one means used to transfer messages to the host channel adapter ports 312-316. Buffering of data to host channel adapter ports 312-316 is channeled through virtual lanes (VL) 318-334 where each VL has its own flow control. Subnet manager configures channel adapters with the local addresses for each physical port, i.e., the port's LID. Subnet manager agent (SMA) 336 is the entity that communicates with the subnet manager for the purpose of configuring the channel adapter. Memory translation and protection (MTP) 338 is a mechanism that translates virtual addresses to physical addresses and to validate access rights. Direct memory access (DMA) 340 provides for direct memory access operations using memory 340 with respect to queue pairs 302-310.

A single channel adapter, such as the host channel adapter 300 shown in FIG. 3, can support thousands of queue pairs. By contrast, a target channel adapter in an I/O adapter typically supports a much smaller number of queue pairs.

Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

The method of using the SAN to send foreign protocols across the network, as defined herein, does not use the queue pairs, but instead bypasses these on the way to the SAN. These foreign protocols, do, however, use the virtual lanes (e.g., virtual lane 334). Many protocols require special ordering of operations in order to prevent deadlocks. A deadlock can occur, for example, when two operations have a dependency on one another for completion and neither can complete before the other completes. The PCI specification, for example, requires certain ordering be followed for deadlock avoidance. The virtual lane mechanism can be used when one operation needs to bypass another in order to avoid a deadlock. In this case, the different operations that need to bypass are assigned to different virtual lanes.

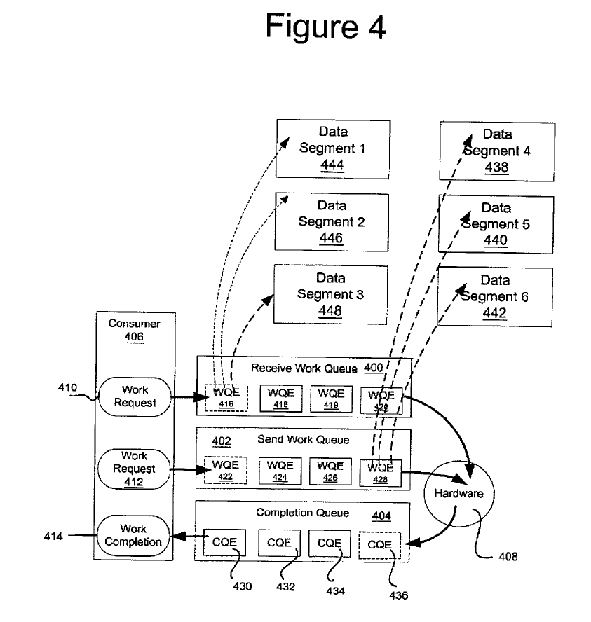

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 402 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses which have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. For example, work queue element 416 in receive work queue 400 references data segment 1 444, data segment 2 446, and data segment 448. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal.

A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a network computing system implementing the present invention supports four types of transport services.

Reliable and Unreliable connected services associate a local queue pair with one and only one remote queue pair. Connected services require a process to create a queue pair for each process which is to communicate with over the SAN fabric. Thus, if each of N host processor nodes contain P processes, and all P processes on each node wish to communicate with all the processes on all the other nodes, each host processor node requires p²×(N−1) queue pairs. Moreover, a process can connect a queue pair to another queue pair on the same host channel adapter.

Reliable datagram service associates a local end-end (EE) context with one and only one remote end-end context. The reliable datagram service permits a client process of one queue pair to communicate with any other queue pair on any other remote node. At a receive work queue, the reliable datagram service permits incoming messages from any send work queue on any other remote node. The reliable datagram service greatly improves scalability because the reliable datagram service is connectionless. Therefore, an endnode with a fixed number of queue pairs can communicate with far more processes and endnodes with a reliable datagram service than with a reliable connection transport service. For example, if each of N host processor nodes contain P processes, and all P processes on each node wish to communicate with all the processes on all the other nodes, the reliable connection service requires p²×(N−1) queue pairs on each node. By comparison, the connectionless reliable datagram service only requires P queue pairs+(N−1) EE contexts on each node for exactly the same communications.

The unreliable datagram service is connectionless. The unreliable datagram service is employed by management applications to discover and integrate new switches, routers, and endnodes into a given network computing system. The unreliable datagram service does not provide the reliability guarantees of the reliable connection service and the reliable datagram service. The unreliable datagram service accordingly operates with less state information maintained at each endnode.

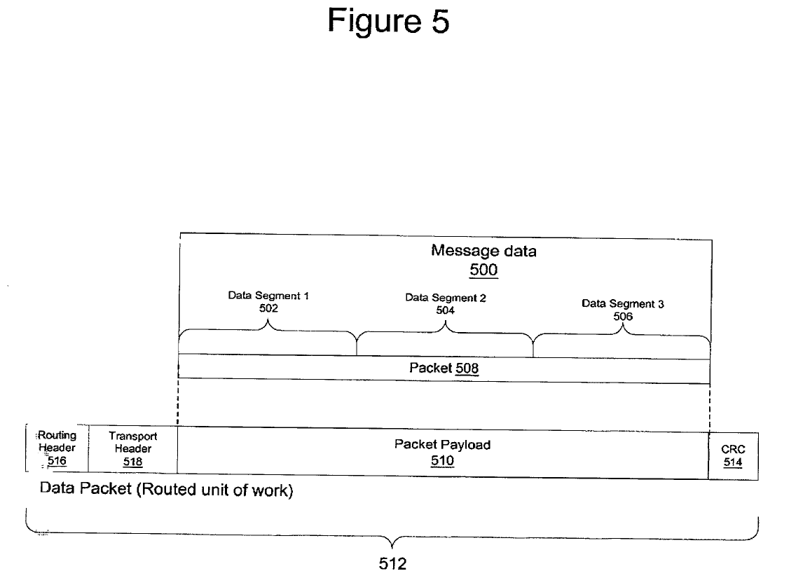

The description of the present invention turns now to identifying service during connection establishment. FIGS. 5, 6, and 7 together illustrate how a service is identified during the connection establishment process.

Turning next to FIG. 5, an illustration of a data packet is depicted in accordance with a preferred embodiment of the present invention. Message data 500 contains data segment 1 502, data segment 2 504, and data segment 3 506, which are similar to the data segments illustrated in FIG. 4. In this example, these data segments form a packet 508, which is placed into packet payload 510 within data packet 512. Additionally, data packet 512 contains CRC 514, which is used for error checking. Additionally, routing header 516 and transport 518 are present in data packet 512. Routing header 516 is used to identify source and destination ports for data packet 512. Transport header 518 in this example specifies the destination queue pair for data packet 512. Additionally, transport header 518 also provides information such as the operation code, packet sequence number, and partition for data packet 512. The operating code identifies whether the packet is the first, last, intermediate, or only packet of a message. The operation code also specifies whether the operation is a send RDMA write, read, or atomic. The packet sequence number is initialized when communications is established and increments each time a queue pair creates a new packet. Ports of an endnode may be configured to be members of one or more possibly overlapping sets called partitions.

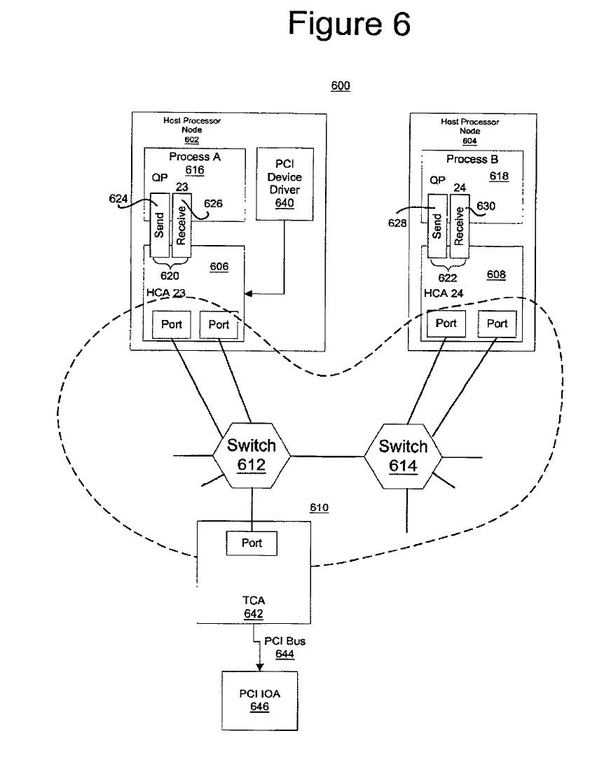

In FIG. 6, a diagram illustrating a portion of a network computing system is depicted in accordance with a preferred embodiment of the present invention. The network computing system 600 in FIG. 6 includes a host processor node 602, a host processor node 604, a SAN fabric 610, and I/O which includes TCA 642 and IOA 646. Host processor node 602 includes a host channel adapter (HCA) 606. Host processor node 604 includes a host channel adapter (HCA) 608. The network computing system in FIG. 6 includes a SAN fabric 610 which includes a switch 612 and a switch 614. SAN fabric 610 in FIG. 6 includes a link coupling host channel adapter 606 to switch 612; a link coupling switch 612 to switch 614; a link coupling switch 612 to TCA 642; and a link coupling host channel adapter 608 to switch 614.

In the example transactions, host processor node 602 includes a client process A 616. Host processor node 604 includes a client process B 618. Client process A 616 interacts with host channel adapter hardware 606 through queue pair 620. Client process B 618 interacts with host channel adapter 608 through queue pair 622. Queue pair 620 and queue pair 622 are data structures. Queue pair 620 includes a send work queue 624 and a receive work queue 626. Queue pair 622 includes a send work queue 628 and a receive work queue 630. All of these queue pairs are unreliable datagram General Service Interface (GSI) queue pairs. GSI queue pairs are used for management including the connection establishment process.

Process A 616 initiates a connection establishment message request by posting send work queue elements to the send queue 624 of queue pair 620. Such a work queue element is illustrated in FIG. 4 above. The message request of client process A 616 is referenced by a gather list contained in the send work queue element. Each of the data segments in the gather list points to a virtually contiguous local memory region, which contains the Connection Management REQuest message. This message is used to request a connection between host channel adapter 606 and host channel adapter 608.

Each process residing in host node processor node 604 communicates to process B 618 the ServiceID which is associated to each specific process. Process B 618 will then compare the ServiceID of incoming REQ messages to the ServiceID associated with each process.

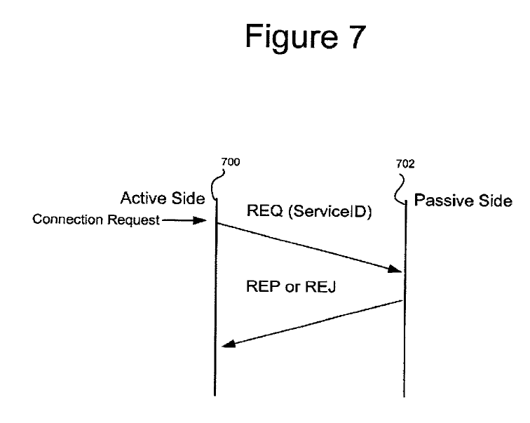

Referring to FIGS. 5 and 7, like all other unreliable datagram (UD) messages, the REQ message sent by process A 616 is a single packet message. Host channel adapter 606 sends the REQ message contained in the work queue element posted to queue pair 620. The REQ message is destined for host channel adapter 608, queue pair 622, and contains a Service ID field. The ServiceID field is used by the destination to determine which consumer is associated to the Service ID. The REQ message is placed in the next available receive work queue element from the receive queue 630 of queue pair 622 in host channel adapter 608. Process B 618 polls the completion queue and retrieves the completed receive work queue element from the receive queue 630 of queue pair 622 in host channel adapter 608. The completed receive work queue element contains the REQ message process A 616 sent. Process B 618 then compares the ServiceID of the REQ message to the ServiceID of each process that has registered itself with process B 618. Registering means that one software process identifies itself to another software process by some predetermined means, such as providing an identifying serviceID. If a match occurs, process B 618 passes the REQ message to the matching process. Otherwise the REQ message is rejected and process B 618 sends process A 616 a REJ message.

If the consumer accepts the messages, the consumer informs process B 618 that the connection establishment REQ has been accepted. Process B 618 responds to the connection establishment REQ by posting send work queue elements to the send queue 628 of queue pair 622. Such a work queue element is illustrated in FIG. 4. The message response of client process B 618 is referenced by a gather list contained in the send work queue element. Each of the data segments in the gather list point to a virtually contiguous local memory region, which contains the Connection Management REPly message. This message is used to accept the connection establishment REQ. If the consumer rejects the message, the consumer informs process B 618 that the connection establishment REQ has been rejected.

If either process B 618 or the consumer reject the message, process B 618 responds to the connection establishment REQ by posting send work queue elements to the send queue 628 of queue pair 622. Such a work queue element is illustrated in FIG. 4. The message response of client process B 618 is referenced by a gather list contained in the send work queue element. Each of the data segments in the gather list point to a virtually contiguous local memory region, which contains the Connection Management REJect message. This message is used to reject the connection establishment REQ.

Referring to FIGS. 5 and 7, the REP message sent by process B 618 is a single packet message. Host channel adapter 608 sends the REP message contained in the work queue element posted to queue pair 622. The REP message is destined for host channel adapter 606, queue pair 620, and contains acceptance of the previous REQ. The acceptance confirms that a process in host channel adapter 608 is indeed associated with the ServiceID sent in the REQ message and lets process A 616 know which queue pair to use to communicate to the process associated with the ServiceID. Upon arriving successfully at host channel adapter 606, the REQ message is placed in the next available receive work queue element from the receive queue 626 of queue pair 620 in host channel adapter 606. Process A 616 polls the completion queue and retrieves the completed receive work queue element from the receive queue 626 of queue pair 620 in host channel adapter 606. The completed receive work queue element contains the REP message sent by process B 618. Process A 616 now knows the service was valid, the queue pair to use to reach it, and that the connection was accepted. Process A 616 proceeds with the remainder of the connection establishment protocol.

Referring again to FIG. 6, another example transaction is between PCI device driver 640 and PCI IOA 646. Store and load requests from the PCI device driver 640 to PCI IOA 646 are encapsulated into a data packet by the HCA 606 for transmission to the TCA 642 corresponding to the PCI IOA 646 across SAN fabric 100. The TCA 642 decodes the data packet to retrieve the PCI transmission and transmits the PCI store or load request and data to PCI IOA 646 via PCI bus 644. If the request is a load request, the TCA 642 then receives a response from the PCI IOA 646 which the TCA encapsulates into a data packet and transmits over the SAN fabric 100 to HCA 606 which decodes the data packet to retrieve the PCI data and commands and sends the PCI data and commands to the requesting PCI device driver 640.

In addition to data needing to be passed back an forth between the processing nodes and the I/O nodes, the I/O also has another mechanism that needs to pass between these endnodes, namely interrupts. Interrupts are used by the I/O adapters to signal their device driver software that an operation is complete or that other servicing is required, for example error recovery. There are different protocols used for signaling interrupts, depending on the I/O protocol.

Many I/O devices use a signal that is activated when the device needs to interrupt for servicing. In this case a way is needed to transport this signal from the device, across the SAN to the processing node. In the preferred embodiment, the interrupt is packetized in a way that is similar to the data packetization described above, with the TCA generating a packet when the interrupt goes from the inactive to the active state, which then gets sent across the SAN to the HCA. The HCA interprets the pack and interrupts the processor in a way that is specific to the processor implementation. When the device driver software has processed the interrupt, it then needs a way to signal both the HCA and the TCA that the operation is complete, so that the controllers at both ends can reset themselves for the next interrupt. This is generally accomplished by a special end of interrupt (EOI) instruction in the software that is interpreted by the HCA to determine that the operation is complete. The HCA then is required to packetize that EOI and send it to the TCA that is handling that interrupt. The process of sending this interrupt across the SAN is similar to the data case. That is, the foreign protocol is encapsulated into the SAN protocol data packet with the appropriate headers and trailers to ensure that the data packet is delivered across the SAN to the appropriate TCA. This foreign protocol for the interrupts may be, for example, similar to what is described in U.S. Pat. No. 5,701,495 entitled “Scalable System Interrupt Structure for a Multi-Processing System,” issued to Arndt, et al. which is hereby incorporated by reference for all purposes.

Another interrupt protocol that is allowed by the PCI specification is the message signaled interrupt (MSI). In this signaling methodology, the interrupt looks to the TCA to be a write to a memory address, the same as any other write operation. In this case, the TCA does not have to deal with any special packetization requirements.

The packets referenced above can be routed within a subnet by switches or between subnets by routers. The protocol supports both cases.

Next, a description of identifying a queue pair to use to communicate to a specific unreliable datagram is presented.

Turning next to FIG. 7, a diagram illustrating messaging occurring during establishment of a connection is depicted in accordance with a preferred embodiment of the present invention. A request is received at active side 700, such as host processor node 602 in FIG. 6. A REQ message including a service ID is sent to passive side 702. Passive side 702 in this example is host processor node 604. A reply accepting the connection request, REP, or a rejection, REJ, is returned to active side 700 from passive side 702 depending on whether the service ID matches or corresponds to a consumer process at passive side 702 and whether such an identified consumer process accepts the request.

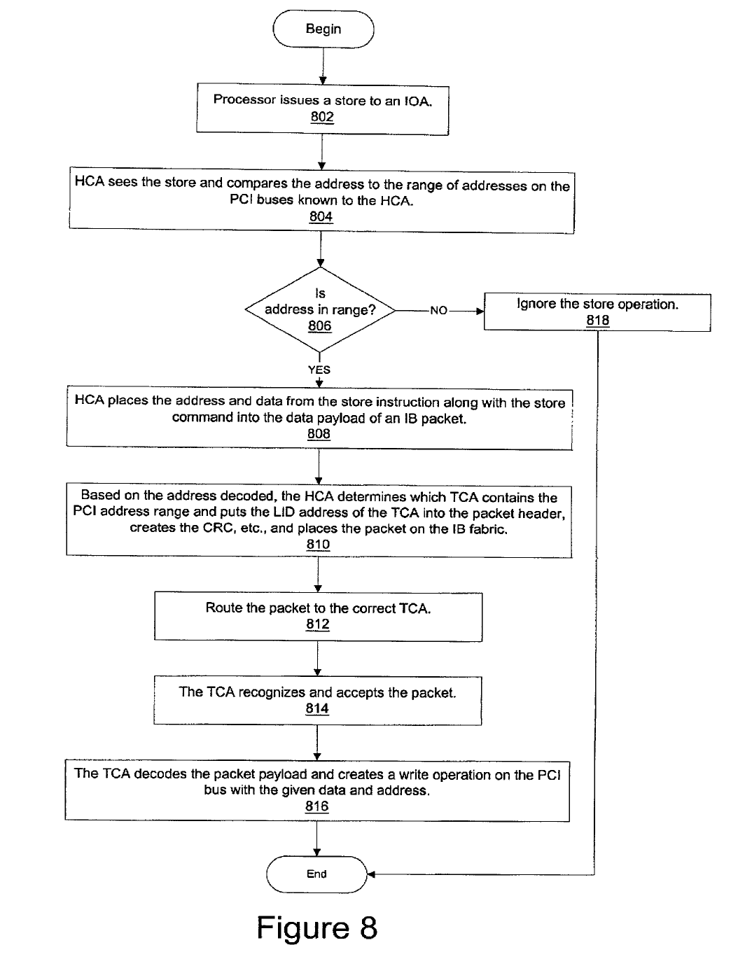

The description of the present invention turns now to a description of PCI transactions performed over Infiniband. FIGS. 8, 9, 10, and 11 together illustrate how PCI transactions are encapsulated into packets and then decoded back into PCI transactions thus allowing PCI transactions to PCI Input/Output adapters to be performed over a packet switched network, such as, for example, one utilizing InfiniBand protocols.

With reference now to FIG. 8, a flowchart illustrating an exemplary method of performing a store operation issued by a processor to a PCI I/O adapter over InfiniBand architecture is depicted in accordance with a preferred embodiment of the present invention. When a processor, such as, for example, CPU 126 in FIG. 1, issues a store command to a PCI I/O adapter (IOA) (step 802), the HCA, such as, for example, HCA 118 in FIG. 1, sees the store command and compares the address within the store command to a range of addresses on the PCI buses known to the HCA (step 804) to determine if the address is within the range (step 806). If the address is not within the range of addresses for the PCI buses known to the HCA, then the HCA ignores the store operation (step 818) and the process ends since the address does not correspond to any of the PCI IOAs within the system known to the HCA.

If the address is within the range of addresses corresponding to one of the PCI IOAs within the system, then the HCA places the address and data from the store instruction along with the store command into the data payload, such as, for example, packet payload 512 in FIG. 5, of an Infiniband (IB) data packet, such as, data packet 500 in FIG. 5 (step 808). Thus, the PCI transaction is encapsulated into packets on the SAN. Based on the address decoded by the HCA when the store operation was observed by the HCA, the HCA determines which TCA, such as TCA 186 in FIG. 1, contains the PCI address range of the address designated by the store operation and puts the LID address of the TCA into the local routing header of the packet (e.g., header 516 of IB packet 500), creates the CRC and other components of the data packet, and places the data packet onto the IB fabric (step 810).

Once the data packet has been placed onto the IB fabric, the data packet is routed to the correct TCA (step 812) which recognizes and accepts the data packet (step 814). The TCA then decodes the data packet payload and creates a write operation on the PCI bus with the given data and address for the PCI IOA specified by the processor (step 816).

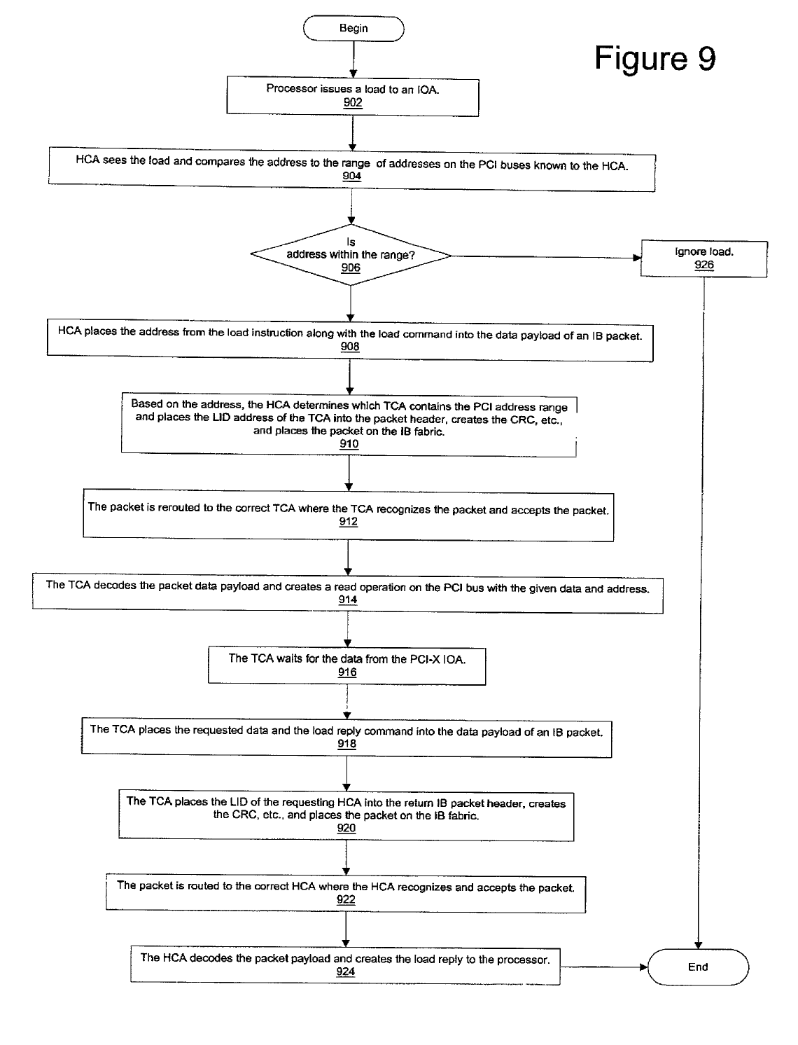

With reference now to FIG. 9, a flowchart illustrating an exemplary method of performing a load operation from a processor to a PCI IOA is depicted in accordance with the present invention. When a processor, such as, for example, CPU 126 in FIG. 1, issues a load command to a PCI I/O adapter (IOA) (step 902), the HCA, such as, for example, HCA 118 in FIG. 1, sees the load command and compares the address in the load command to the range of addresses of the PCI buses known to the HCA (step 904) and determines whether the address in the load command is within the range (step 906). If the address in the load command is not within the range of addresses of PCI buses known to he HCA, then the load command is ignored (step 926) and the process ends.

If the address within the load command is within the range of addresses for the PCI buses known to the HCA, then the HCA places the address from the load instruction along with the load command into the data packet payload of an IB packet, such as, for example, data packet payload 512 of IB packet 500 in FIG. 5 (step 908). Based on the address in the load command, the HCA determines which TCA, such as, for example, TCA 186 in FIG. 1, contains the appropriate PCI address range and then places the LID address of the TCA into the local routing header of the packet, such as, for example, header 516 of IB packet 500 in FIG. 5, creates the CRC as well as other components of the data packet, and places the data packet onto the IB fabric (step 910). The data packet is then rerouted to the correct TCA where the TCA recognizes and accepts the data packet (step 912).

Once the TCA has accepted the data packet, the TCA decodes the packet data payload and creates a read operation on the PCI bus with the given data and address of the load operation (step 914). The TCA waits for the data from the PCI-X IOA (step 916) or alternatively, if the IOA is a PCI IOA rather than a PCI-X IOA, the HCA retries the IOA until it receives the requested data from the IOA. Once the requested data has been received by the TCA, the TCA places the requested data and the Load Reply command into the data payload of an IB packet (step 918). The TCA then places the LID of the requesting HCA, which is remembered from the initial Load request packet, into the return IB packet header, creates the CRC and other components of the data packet, and then places the data packet onto the IB fabric (step 920). The data packet is then routed to the correct HCA which recognizes and accepts the packet (step 922). The HCA then decodes the packet payload and creates and sends the Load Reply to the processor (step 924).

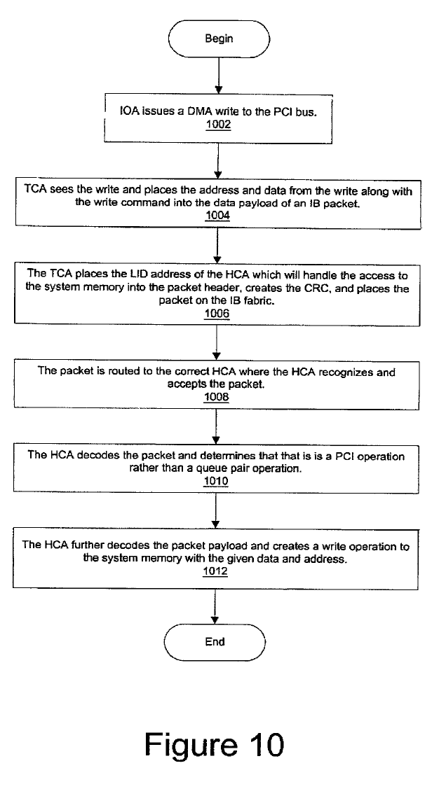

With reference now to FIG. 10, a flowchart illustrating an exemplary method of performing a direct memory access read (DMA) operation from a PCI I/O adapter to system memory across an Infiniband system is depicted in accordance with a preferred embodiment of the present invention. When a PCI or PCI-X IOA issues a direct memory access write command to the PCI bus (step 1002), the TCA sees the write and places the address and data from the write along with the write command into the data payload of an IB packet (step 1004). The TCA then places the LID address of the HCA which will handle the access to the system memory into the local routing header of the packet, such as, for example, header 516 of IB packet 500 in FIG. 5, creates the CRC and other components of the data packet, and places the data packet on the IB fabric (step 1006). The packet is then routed to the correct HCA where the HCA recognizes and accepts the data packet (step 1008). The HCA decodes the packet and determines that it is a PCI operation rather than a queue pair operation (step 1010). Once the HCA determines that the data packet is a PCI operation, the HCA further decodes the packet payload and creates a write operation to the system memory with the given data and address (step 1012), thus completing the DMA write operation from a PCI I/O adapter to the system memory.

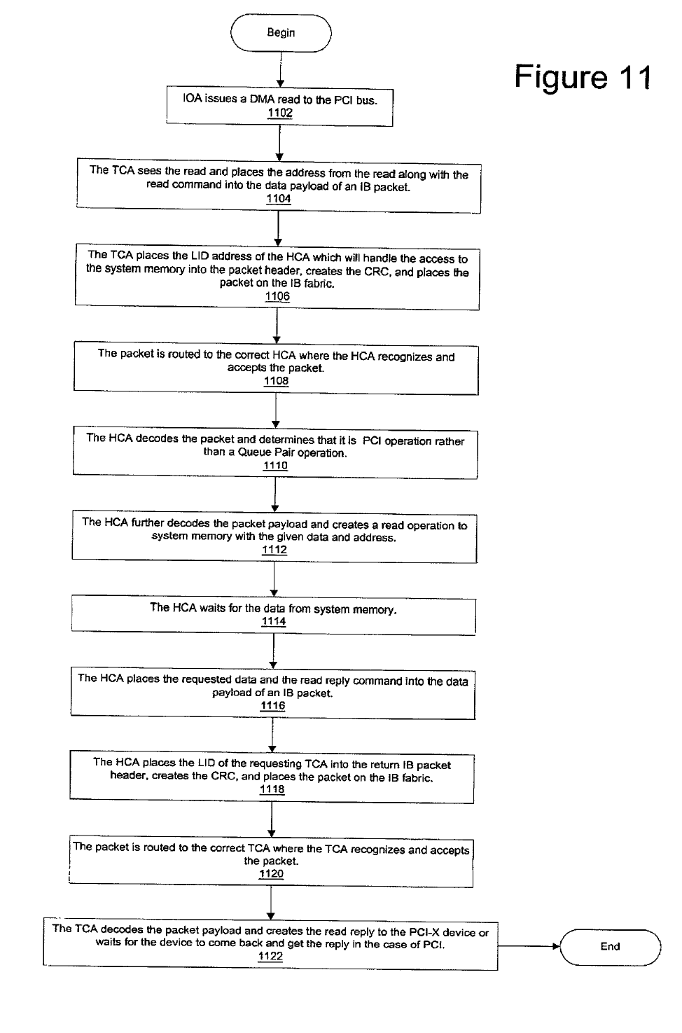

With reference now to FIG. 11, a flowchart illustrating a direct memory access read operation from a PCI I/O adapter to system memory across an InfiniBand connection is depicted in accordance with a preferred embodiment of the present invention. When the PCI I/O adapter issues a DMA read operation to the PCI bus (step 1102), the TCA sees the read and places the address from the read along with the read command into the data payload of an IB packet (step 1104). The TCA then places the LID address of the HCA which will handle the access to the system memory into the local routing header of the packet, such as, for example, header 516 of IB packet 500 in FIG. 5, creates the CRC as well as other components of the data packet, and places the data packet onto the IB fabric (step 1106). The data packet is then routed to the correct HCA which then recognizes and accepts the data packet (step 1108).

Once the HCA has accepted the data packet, the HCA decodes the packet and determines that the data packet is a embedded PCI transaction rather than a Queue Pair operation (step 1110). The HCA then further decodes the packet payload and creates and sends a PCI read operation to the system memory with the given data and address as extracted from the data payload (step 1112). The HCA waits for the data to be returned from the system memory (step 1114) and when received, placed the requested data and the Read Reply command into a data payload of an IB packet (step 1116). The HCA then places the LID of the requesting TCA into the return IB local routing header of the packet, such as, for example, header 516 of IB packet 500 in FIG. 5, creates the CRC and other components of the data packet, and places the data packet onto the IB fabric (step 1118). The data packet is then routed to the correct TCA which then recognizes and accepts the data packet (step 1120). The TCA then decodes the packet payload and creates and sends the Read Reply to the PCI-X device or, alternatively, if the I/O adapter is a PCI device rather than a PCI-X device, waits for the I/O device to retrieve the reply (step 1122), thus completing the DMA read operation from a PCI I/O adapter to system memory across an IB fabric.

IB defines several types of packets, defined by the operation code in the header: Reliable Connected (RC), Reliable datagram (RD), Unreliable Connected (UC), Unreliable Datagram (UD), Raw Datagram (RawD), and a set of manufacturer definable operation codes. By using the manufacturer definable codes, it is possible to define a packet type that has the characteristics of the reliable packet types for PCI operations over the IB fabric.

Reliable operations are important for PCI because the load/store model used for most PCI adapters is such that if one of the loads or stores is lost due to an error, the results can be unpredictable I/O adapter operation which might lead to loss of customer data (e.g., writing to wrong addresses) or security problems (e.g., reading data from one person's area in memory and writing it to another person's disk area). Unreliable types could be used, bus since there is no high level protocol that will protect against unpredictable operations, this is not a good idea for these type adapters. Nonetheless, this patent allows for the use of, for example, the RawD type packet for transmission of PCI packets across the IB fabric. The advantage of use of the RawD type packet would be that it provides less overhead (i.e., fewer header bytes per packet) and less IB fabric overhead (i.e., due to no acknowledgment packets), and therefore might have some use in some applications.

Although the present invention has been described primarily with respect to PCI bus protocols, it will be recognized by those skilled in the art that the processes and apparatuses of the present invention may be applied to other types of bus protocols as well, such as, for example, ISA protocols. Therefore, the present invention is not limited to application to PCI and PCI-X adapters, but may be applied to other types of I/O adapters as well. In addition, this invention is not limited to the application only to I/O, but may be applied to other operations and configurations such as Cache Coherent Non-Uniform Memory Access (NUMA or CCNUMA) and Scalable Coherent Memory Access (SCOMA) applications.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for processing foreign protocol requests across a system area network, the method comprising:
receiving a request from a device utilizing a protocol which is foreign to a protocol utilized by the system area network;
encapsulating the request in a data packet; and
sending the data packet to a requested node via the system area network fabric.

2. The method as recited in claim 1, wherein the request is a first request, the data packet is a first data packet, and the sending the data packet comprises sending the data packet on a first virtual lane, and further comprising:
receiving a second request from a device utilizing a protocol which is foreign to the protocol utilized by the system area network;
encapsulating the second request in a second data packet; and
responsive to a determination that the first and second requests are to be kept in order, sending the second data packet to a requested node via the first virtual lane on the system area network fabric.

3. The method as recited in claim 1, wherein the request is a first request, the data packet is a first data packet, and the sending the data packet comprises sending the data packet on a first virtual lane, and further comprising:
receiving a second request from a device utilizing a protocol which is foreign to the protocol utilized by the system area network;
encapsulating the second request in a second data packet; and
responsive to a determination that the first and second requests should be able to bypass the other, sending the second data packet to a requested node via a second virtual lane on the system area network fabric.

4. The method as recited in claim 1, wherein the request is an interrupt received by a target channel adapter and further comprising:
receiving the data packet, at a host channel adapter, and decoding the data packet to retrieve the interrupt; and
interrupting the processor.

5. The method as recited in claim 4, wherein the data packet is a first data packet and further comprising:
receiving, at the host channel adapter, an end of interrupt instruction;
encapsulating the end of interrupt instruction into a second data packet; and
transmitting the second data packet to the target channel adapter via the system area network fabric.

6. The method as recited in claim 5, further comprising:
receiving the second data packet;
decoding the second data packet to determine that the interrupt is complete.

7. The method as recited in claim 1, wherein the foreign protocol is a peripheral component interconnect bus protocol.

8. The method as recited in claim 1, further comprising:
receiving, at the requested node, the data packet;
decoding the data packet to obtain the foreign protocol request; and
transmitting the foreign protocol request to an appropriate device.

9. The method as recited in claim 1, wherein the steps of receiving a request, encapsulating the request, and sending the data packet are performed by a host channel adapter.

10. The method as recited in claim 1, wherein the requested node is a target channel adapter.

11. The method as recited in claim 8, wherein the steps of receiving, at the requested node, the data packet, decoding the data packet, and transmitting the foreign protocol request are performed by a target channel adapter.

12. The method as recited in claim 8, wherein the steps of receiving, at the requested node, the data packet, decoding the data packet, and transmitting the foreign protocol request are performed by a host channel adapter.

13. The method as recited in claim 8, wherein the step of transmitting the foreign protocol request comprises converting the request to an appropriate host transaction.

14. The method as recited in claim 1, wherein the steps of receiving a request, encapsulating the request, and sending the data packet are performed by a target channel adapter.

15. The method as recited in claim 1, wherein the requested node is a host channel adapter.

16. The method as recited in claim 1, wherein the step of encapsulating the foreign protocol request comprises placing the request into a data packet with appropriate headers and trailers in the data packet to ensure that the data packet is delivered across the system area network fabric to the requested node.

17. The method as recited in claim 8, wherein the step of decoding the data packet comprises determining that the data packet contains a foreign protocol request and removing the foreign protocol request from the data packet.

18. A method for processing foreign protocol requests across a system area network, the method comprising:
receiving a data packet from a system area network fabric;
determining that the data packet contains an encapsulated foreign protocol transmission;
decoding the data packet to obtain the foreign protocol transmission; and
sending the foreign protocol transmission to a requested device.

19. The method as recited in claim 18, wherein the foreign protocol is a peripheral component interconnect bus protocol.

20. The method as recited in claim 18, wherein the requested device is an input/output adapter.

21. The method as recited in claim 18, wherein the steps of receiving, determining, decoding, and sending are performed by a target channel adapter.

22. The method as recited in claim 18, wherein the steps of receiving, determining, decoding, and sending are performed by a host channel adapter.

23. The method as recited in claim 22, wherein the step of sending comprises converting the foreign protocol request to an appropriate host transaction.

24. A computer program product in a computer readable media for use in a networked data processing system for processing foreign protocol requests across a system area network, the computer program product comprising:
first instructions for receiving a request from a device utilizing a protocol which is foreign to a protocol utilized by the system area network;
second instructions for encapsulating the request in a data packet; and
third instructions for sending the data packet to a requested node via the system area network fabric.

25. The computer program product as recited in claim 24, wherein the request is a first request, the data packet is a first data packet, and the sending the data packet comprises sending the data packet on a first virtual lane, and further comprising:
fourth instructions for receiving a second request from a device utilizing a protocol which is foreign to the protocol utilized by the system area network;
fifth instructions for encapsulating the second request in a second data packet; and
sixth instructions, responsive to a determination that the first and second requests are to be kept in order, for sending the second data packet to a requested node via the first virtual lane on the system area network fabric.

26. The computer program product as recited in claim 24, wherein the request is a first request, the data packet is a first data packet, and the sending the data packet comprises sending the data packet on a first virtual lane, and further comprising:
fourth instructions for receiving a second request from a device utilizing a protocol which is foreign to the protocol utilized by the system area network;
fifth instructions for encapsulating the second request in a second data packet; and
sixth instructions, responsive to a determination that the first and second requests should be able to bypass the other, for sending the second data packet to a requested node via a second virtual lane on the system area network fabric.

27. The computer program product as recited in claim 24, wherein the request is an interrupt received by a target channel adapter and further comprising:
fourth instructions for receiving the data packet, at a host channel adapter, and decoding the data packet to retrieve the interrupt; and
fifth instructions for interrupting the processor.

28. The computer program product as recited in claim 27, wherein the data packet is a first data packet and further comprising:
sixth instructions for receiving, at the host channel adapter, an end of interrupt instruction;
seventh instructions for encapsulating the end of interrupt instruction into a second data packet; and
eighth instructions for transmitting the second data packet to the target channel adapter via the system area network fabric.

29. The computer program product as recited in claim 28, further comprising:
ninth instructions for receiving the second data packet;
tenth instructions for decoding the second data packet to determine that the interrupt is complete.

30. The computer program product as recited in claim 24, wherein the foreign protocol is a peripheral component interconnect bus protocol.

31. The computer program product as recited in claim 24, further comprising:
fourth instructions for receiving, at the requested node, the data packet;
fifth instructions for decoding the data packet to obtain the foreign protocol request; and
sixth instructions for transmitting the foreign protocol request to an appropriate device.

32. The computer program product as recited in claim 24, wherein the steps of receiving a request, encapsulating the request, and sending the data packet are performed by a host channel adapter.

33. The computer program product as recited in claim 24, wherein the requested node is a target channel adapter.

34. The computer program product as recited in claim 31, wherein the instructions for receiving, at the requested node, the data packet, decoding the data packet, and transmitting the foreign protocol request are performed by a target channel adapter.

35. The computer program product as recited in claim 31, wherein the instructions for receiving, at the requested node, the data packet, decoding the data packet, and transmitting the foreign protocol request are performed by a host channel adapter.

36. The computer program product as recited in claim 31, wherein the instructions for transmitting the foreign protocol request comprises converting the request to an appropriate host transaction.

37. The computer program product as recited in claim 24, wherein the instructions for receiving a request, encapsulating the request, and sending the data packet are performed by a target channel adapter.

38. The computer program product as recited in claim 24, wherein the requested node is a host channel adapter.

39. The computer program product as recited in claim 24, wherein the instructions for encapsulating the foreign protocol request comprises placing the request into a data packet with appropriate headers and trailers in the data packet to ensure that the data packet is delivered across the system area network fabric to the requested node.

40. The computer program product as recited in claim 31, wherein the instructions for decoding the data packet comprises determining that the data packet contains a foreign protocol request and removing the foreign protocol request from the data packet.

41. A computer program product in a computer readable media for use in a data processing system for processing foreign protocol requests across a system area network, the computer program product comprising:
first instructions for receiving a data packet from a system area network fabric;
second instructions for determining that the data packet contains an encapsulated foreign protocol transmission;
third instructions for decoding the data packet to obtain the foreign protocol transmission; and
fourth instructions for sending the foreign protocol transmission to a requested device.

42. The computer program product as recited in claim 41, wherein the foreign protocol is a peripheral component interconnect bus protocol.

43. The computer program product as recited in claim 41, wherein the requested device is an input/output adapter.

44. The computer program product as recited in claim 41, wherein the instructions for receiving, determining, decoding, and sending are performed by a target channel adapter.

45. The computer program product as recited in claim 41, wherein the instructions for receiving, determining, decoding, and sending are performed by a host channel adapter.

46. The computer program product as recited in claim 45, wherein the instructions for sending comprises converting the foreign protocol request to an appropriate host transaction.

47. A system for processing foreign protocol requests across a system area network, the system comprising:
first means for receiving a request from a device utilizing a protocol which is foreign to a protocol utilized by the system area network;
second means for encapsulating the request in a data packet; and
third means for sending the data packet to a requested node via the system area network fabric.

48. The system as recited in claim 47, wherein the request is a first request, the data packet is a first data packet, and the sending the data packet comprises sending the data packet on a first virtual lane, and further comprising:
fourth means for receiving a second request from a device utilizing a protocol which is foreign to the protocol utilized by the system area network;
fifth means for encapsulating the second request in a second data packet; and
sixth means, responsive to a determination that the first and second requests are to be kept in order, for sending the second data packet to a requested node via the first virtual lane on the system area network fabric.

49. The system as recited in claim 47, wherein the request is a first request, the data packet is a first data packet, and the sending the data packet comprises sending the data packet on a first virtual lane, and further comprising:
fourth means for receiving a second request from a device utilizing a protocol which is foreign to the protocol utilized by the system area network;
fifth means for encapsulating the second request in a second data packet; and
sixth means, responsive to a determination that the first and second requests should be able to bypass the other, for sending the second data packet to a requested node via a second virtual lane on the system area network fabric.

50. The system as recited in claim 47, wherein the request is an interrupt received by a target channel adapter and further comprising:
fourth means for receiving the data packet, at a host channel adapter, and decoding the data packet to retrieve the interrupt; and
fifth means for interrupting the processor.

51. The system as recited in claim 50, wherein the data packet is a first data packet and further comprising:
sixth means for receiving, at the host channel adapter, an end of interrupt instruction;
seventh means for encapsulating the end of interrupt instruction into a second data packet; and
eighth means for transmitting the second data packet to the target channel adapter via the system area network fabric.

52. The system as recited in claim 51, further comprising:
ninth means for receiving the second data packet;
tenth means for decoding the second data packet to determine that the interrupt is complete.

53. The system as recited in claim 47, wherein the foreign protocol is a peripheral component interconnect bus protocol.

54. The system as recited in claim 47, further comprising:
fourth means for receiving, at the requested node, the data packet;
fifth means for decoding the data packet to obtain the foreign protocol request; and
sixth means for transmitting the foreign protocol request to an appropriate device.

55. The system as recited in claim 47, wherein the steps of receiving a request, encapsulating the request, and sending the data packet are performed by a host channel adapter.

56. The system as recited in claim 47, wherein the requested node is a target channel adapter.

57. The system as recited in claim 54, wherein the means for receiving, at the requested node, the data packet, decoding the data packet, and transmitting the foreign protocol request are performed by a target channel adapter.

58. The system as recited in claim 54, wherein the means for receiving, at the requested node, the data packet, decoding the data packet, and transmitting the foreign protocol request are performed by a host channel adapter.

59. The system as recited in claim 54, wherein the means for transmitting the foreign protocol request comprises converting the request to an appropriate host transaction.

60. The system as recited in claim 47, wherein the means for receiving a request, encapsulating the request, and sending the data packet are performed by a target channel adapter.

61. The system as recited in claim 47, wherein the requested node is a host channel adapter.

62. The system as recited in claim 47, wherein the means for encapsulating the foreign protocol request comprises placing the request into a data packet with appropriate headers and trailers in the data packet to ensure that the data packet is delivered across the system area network fabric to the requested node.

63. The system as recited in claim 54, wherein the means for decoding the data packet comprises determining that the data packet contains a foreign protocol request and removing the foreign protocol request from the data packet.

64. A system for processing foreign protocol requests across a system area network, the system comprising:
first means for receiving a data packet from a system area network fabric;
second means for determining that the data packet contains an encapsulated foreign protocol transmission;
third means for decoding the data packet to obtain the foreign protocol transmission; and
fourth means for sending the foreign protocol transmission to a requested device.

65. The system as recited in claim 64, wherein the foreign protocol is a peripheral component interconnect bus protocol.

66. The system as recited in claim 64, wherein the requested device is an input/output adapter.

67. The system as recited in claim 64, wherein the means for receiving, determining, decoding, and sending are performed by a target channel adapter.

68. The system as recited in claim 64, wherein the means for receiving, determining, decoding, and sending are performed by a host channel adapter.

69. The system as recited in claim 68, wherein the means for sending comprises converting the foreign protocol request to an appropriate host transaction.
